(19) United States
(12) Patent Application Publication
(10) Pub. No.: US 2009/0057631 A1
(43) Pub. Date: Mar. 5, 2009

(54) GEARLESS ABSEILING DEVICE

(75) Inventor: Kai Rinklake, Neuwied (DE)

Correspondence Address: LAW OFFICE OF DELIO & PETERSON, LLC., 121 WHITNEY AVENUE, 3RD FLLOR, NEW HAVEN, CT, 06510, US

(73) Assignee: SKYLOTEC GMBH, Neuweid, DE (DE)

(21) Appl. No.: 12/280,642

(22) PCT Filed: Feb. 15, 2007
(86) PCT No.: PCT/EP07/01330

§ 371 Date: Aug. 25, 2008

(30) Foreign Application Priority Data
Feb. 27, 2006 (DE) 10 2006 009 050.0

(51) Int. Cl. A62B 1/14

(52) U.S. Cl. 254/277

(57) ABSTRACT

The invention relates to an abseiling device comprising a cable feeding point and a cable output point (26) for a safety cable (16) comprising a disk (10) for the cable and a brake device (12) for the disk (10). The brake device (12) is arranged on the same shaft (14) as the cable disk (10). At least one friction brake (20) is also arranged on the abseiling device in such a way that it directly interacts with the safety cable (16), braking the same by means of frictional engagement.

The present invention relates to an abseiling device comprising a cable feed point and a cable output point for a safety cable, comprising a cable disk and a brake device for the cable disk, wherein the brake device is arranged on the same shaft as the cable disk and wherein additionally at least one friction brake is arranged and configured such that the friction brake directly interacts with the safety cable, braking said safety cable by means of frictional engagement, according to the preamble of claim 1.

DE 23 26 041 C3 discloses an abseiling device comprising a cable disk and a brake device for the cable disk. The brake device comprises a centrifugal braking device with weights which can be brought into rotation and an oil hydraulic brake device of the rotary pump type or the gear pump type. The oil hydraulic brake device is connected to the cable disk via a coupling and the centrifugal brake device is connected to the cable disk via a planetary acceleration gear The brake device and the cable disk are arranged on a common shaft.

U.S. Pat. No. 1,031,909 describes an emergency abseiling device which has a centrifugal brake which is connected to a cable disk. Arranged at the cable feeding point and the cable output point, respectively, is an additional brake shoe. A cable winds round the cable disk and as the speed of the cable increases, the centrifugal brake exerts an increasing brake force.

From U.S. Pat. No. 7,743,355, an emergency abseiling device is known wherein a cable disk is connected to a carrier for weights. The weights are pivotably arranged on the carrier and pressed radially outwardly by the centrifugal force during rotation of the carrier. By this means, the brake shoes are pressed against a fixed brake disk. Arranged at the cable feeding point and the cable output point are rotatable rollers as guides for a cable. However, these have no braking function.

DE 38 26 404 A1 discloses a hydraulic rapid descent device wherein a cable interacts with a disk wheel or a roller and drives a gearing device. Three rotatable guide rollers are arranged on a rocker at the cable feeding point/output point. However, these have no braking function.

EP 163 938 A1 describes a rescue and sliding device, wherein by means of a manually actuated lever, a cable sliding through is more or less jammed in, so that a more or less strong braking effect is produced on the cable. This device can, for example, be firmly hung up and a person hanging from the cable can be let down slowly by another person by actuating the lever. In this function, guide rollers are arranged at a cable feeding point. A frictional force is only exerted on the cable by means of the lever with the associated clamping parts. The guide rollers only serve a guiding function. Friction braking by means of the guide rollers is not disclosed in EP 163 938 A1. Furthermore, a cable disk round which the cable winds and a brake device therefor is not disclosed.

U.S. Pat. No. 139,484 discloses an emergency abseiling device which has an L-shaped lever arm on whose two free ends two openings are formed through which a cable runs. This lever arm has the following functions: throwing the upwardly running cable away from the downwardly running cable; guiding the upwardly running cable in a housing and bringing it into contact with a drum; and preventing sliding of the cable on the drum. A braking effect applied by the lever arm on the cable is not provided.

It is an object of the invention to improve an abseiling device of the aforementioned type with regard to functional reliability and ease of use.

This aim is achieved according to the invention by an abseiling device of the aforementioned type having the features characterised in claim 1. Advantageous embodiments of the invention are described in the other claims.

In an abseiling device of the aforementioned type, it is provided according to the invention that the friction brake has at least three fixed bolts which are arranged such that the safety cable is threaded round the bolts and lies against all the bolts.

This has the advantage that the forces arising are partially absorbed by the friction brake. By this means, it is possible to dispense with an additional gearbox between the cable disk and the brake device for the cable disk, so that the abseiling device has parts which are less prone to problems and less in need of maintenance and servicing.

For example, the brake device comprises a centrifugal coupling and/or an oil hydraulic brake.

The friction brake is arranged, for example, only at the cable output point.

The invention will now be described in greater detail by reference to the drawings, in which:

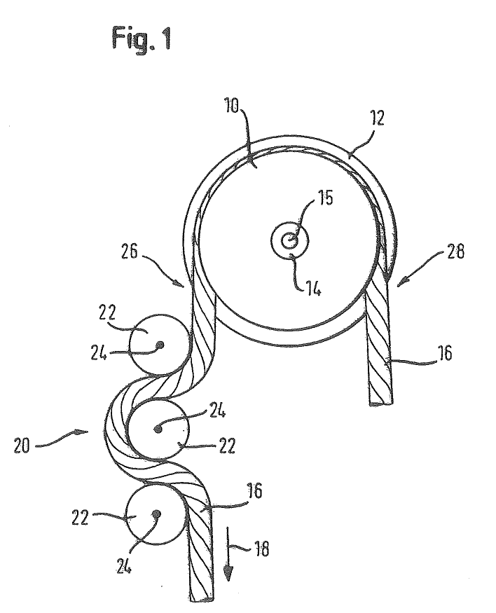

FIG. 1 shows a preferred embodiment of an abseiling device according to the invention in a schematic side view, and

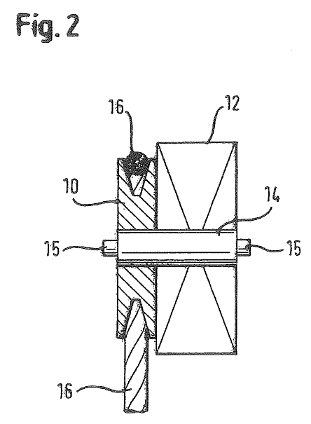

FIG. 2 in a schematic sectional view.

The preferred embodiment of an abseiling device according to the invention shown in FIGS. 1 and 2 comprises a cable disk 10 and a brake device 12 for the cable disk 10, wherein the cable disk 10 and the brake device 12 are arranged on a common shaft 14 with a bearing 15. The brake device is, for example, a centrifugal coupling or an oil hydraulic brake. A safety cable 16 runs round the cable disk 10 in essentially slip-free manner, so that the brake device 12 keeps a movement velocity of the safety cable 16 through the abseiling device below a predetermined value and substantially constant. The present abseiling device is therefore such a one in which the safety cable runs through the abseiling device which is fixed at one site without thereby becoming wound up or unwound in or by the abseiling device.

Additionally, according to the invention, arranged on one side of the cable disk 10 on which the safety cable 16 moves out of the abseiling device, or away from the cable disk 10 (the movement direction of the safety cable is indicated by the arrow 18), is an additional friction brake 20 for the safety cable 16. In the exemplary embodiment shown, this friction brake 20 comprises three fixed bolts 22 round which the safety cable 16 is threaded so that it lies against all the bolts 22. For this purpose, the bolts 22 are arranged such that their respective longitudinal axes 20 lie in one line. Due to the frictional engagement of the safety cable 16 on the bolts 22, part of the forces arising is absorbed by this friction brake 20 and therefore relieves the cable disk 10 or the brake device 12.

The reference sign 26 denotes a cable output point and 28 denotes a cable feeding point. In normal operation, during abseiling of a person, the safety cable moves in the direction of the arrow 18, so that at the cable output point, the safety cable 16 moves out of the abseiling device or away from the cable disk 10 and at the cable feeding point 28, the cable runs into the abseiling device or towards the cable disk 10. The friction brake 20 is therefore arranged at the cable output point.

In a preferred development (not shown), it is provided that a friction brake is additionally provided at the cable feeding point, wherein both friction brakes are then configured such that the friction brake at which the safety cable moves into the abseiling device releases the safety cable and the friction brake at which the safety cable moves out of the abseiling device applies a frictional force to the safety cable. By this means, the abseiling device operates two-sidedly and independently of the direction in which the safety cable runs round the cable disk, for example, also if the safety cable moves relative to the abseiling device in the direction opposed to the arrow 18.

1. Abseiling device comprising a cable feed point and a cable output point for a safety cable, comprising a cable disk and a brake device for the cable disk, wherein the brake device is arranged on the same shaft as the cable disk and wherein additionally at least one friction brake is arranged and configured such that the friction brake directly interacts with the safety cable, braking the safety cable by means of frictional engagement, the friction brake including at least three fixed bolts (22) which are arranged such that the safety cable is threaded round the bolts and lies against all of the bolts.

2. The abseiling device of claim 1, including having the brake device comprise a centrifugal coupling, an oil hydraulic brake, or both.

3. The abseiling device of claim 1, including having the at least three fixed bolts arranged such that their longitudinal axes lie in one line.

4. The abseiling device of claim 1, including having the friction brake arranged at the cable output point.

5. The abseiling device of claim 2, including having the at least three fixed bolts arranged such that their longitudinal axes lie in one line.

6. The Abseiling abseiling device of claim 2, including having the friction brake arranged at the cable output point.

7. The Abseiling abseiling device of claim 3, including having the friction brake arranged at the cable output point.
